(19) United States
(12) Patent Application Publication
(10) Pub. No.: US 2019/0281908 A1
(43) Pub. Date: Sep. 19, 2019

(54) CLOTHING FORMED WITH SILICONE PATTERNS IN TAPING FORM FOR EMITTING ANIONS AND METHOD OF MANUFACTURING SAME

(71) Applicants: GMK CO., LTD., Gyeonggi-do (KR); ENERSKIN INC., Seoul (KR)

(72) Inventor: Tae Gil Park, Gyeonggi-do (KR)

(21) Appl. No.: 15/921,995

(22) Filed: Mar. 15, 2018

(51) Int. Cl. A41D 31/00; C09J 183/04; C09J 11/04; A41D 1/00

(52) U.S. Cl. CPC A41D 31/00; C09J 183/04; C09J 11/04; B05D 1/02; A41D 2500/30; A41D 2400/32; A41D 2400/22; A41D 1/00

(57) ABSTRACT

The present invention relates to clothing having a silicone pattern formed to correspond to the shape of the muscles of the human body and a method of manufacturing the same, in which a silicone resin is formed on a clothing fabric using a fine spray method so as to include anion ore powder in a silicone pattern, and a pore-forming agent for forming micropores and a photocatalyst material are further added into a liquid silicone resin so that the silicone pattern is expanded and contracted to correspond to the expansion and contraction forces of the fabric, and the anion emission efficiency of the silicone pattern can be further increased.

### BACKGROUND

### 1. Field of the Invention

The present invention relates to clothing in which a silicone pattern emitting anions is formed in a taping form, and a method of manufacturing the same, and more specifically, to clothing in which a silicone pattern emitting anions is formed in a taping form, the silicone pattern is formed on clothing using an anion-emitting material, thereby improving the blood circulation of the human body and alleviating fatigue by anions, and the silicone pattern expands in accordance with the degree of expansion of the clothing to maintain the adhesion of the silicone pattern and improve durability, and a method of manufacturing the same.

### 2. Discussion of Related Art

Generally, clothing has been developed as a medium for the desire of expression of the human along with the history of mankind, and has begun with the practicality of controlling heat or cold in response to climate changes or protecting the body from obstacles from the outside, and decorativeness and sociality have gradually been added thereto. Such changes and developments are, of course, important factors in promoting the development of clothing, aesthetically and scientifically, and materials are freely chosen according to purpose, and the creation of more beautiful and functional clothing has been continued.

Recently, clothing has been manufactured to be easy to work, and the proportion of clothes is gradually increasing as the tendency of clothing to be used for various purposes such as focusing on functional aspects or pursuing decorativeness is increasing.

Particularly, products combining Kinesio taping and sports taping, which form a three-dimensional pattern to match the shape of muscles of the human body, have been developed. Kinesio taping is a taping technique which can reduce pain and exhibit an exercise effect by applying an elastic adhesive tape on the skin to smooth the blood circulation.

Korean Patent No. 1503422 discloses a technical content registered in the name of “Functional compression clothing in which the molding of Kinesio taping and sports taping is formed of silicone inside the fabric”.

As shown in FIG. 1, in the functional clothing to which the Kinesio taping technique is applied, compression clothing is disclosed in which a taping mold is formed by a silicone molding layer 2 such as Kinesio taping and sports taping using silicone on a surface of a high elasticity synthetic fiber knitted fabric 1 having a pattern formed corresponding to the shape of muscles of the human body, and a plurality of through-holes 3 for ventilation and sweat discharging are formed and sewing is performed by screen printing to form a construction and compression force to maximize taping functionality.

The compression clothing to which a Kinesio taping method is applied is convenient to use because there is no need for taping directly on the skin. Further, the compression clothing allows users to easily wear the clothing due to being printed with a highly elastic material such as silicone, and the users can put the compression clothing on the desired body part alone without any expertise.

Further, the applicant of the present invention has proposed a technique of improving the blood circulation of the human body, alleviating fatigue, and improving adhesiveness and washing fastness after washing by preparing a silicone patch using an anion-emitting material and adhering the silicone patch to clothing, in Korean Patent No. 1604713 (Clothing having anion-emitting silicone patch attached thereto and method for manufacturing same) filed by the applicant on Sep. 16, 2015 and registered on Mar. 25, 2016.

Although it is possible to realize the synergistic action of the blood circulation effect by the taping technique and the blood circulation effect by the anion by combining the function of the silicone patch which emits the anion proposed by the applicant of the present invention with the compression clothing to which the conventional taping technique is applied, such technology has not been proposed yet.

Further, in the compression clothing to which the conventional taping technique is applied, the degree of expansion of the knitted fabric and the degree of expansion of the silicone pattern are different, so that there arises a problem that the silicone pattern is lifted or dropped when the clothing is used for a long period of time, thereby reducing durability.

Moreover, the silicone pattern formed on the compression clothing to which the conventional taping technique is applied has a problem in that an artificial vent hole should be formed by forming a separate hole because air ventilation is poor.

### RELATED ART DOCUMENT

### Patent Document

(Patent Document 0001) Korean Patent No. 10-1604713

(Patent Document 0002) Korean Patent No. 10-1503422

### SUMMARY OF THE INVENTION

It is an object of the present invention to combine taping functionality with anion emission functionality to improve blood circulation functionality and alleviate fatigue.

It is another object of the present invention to improve adhesion of a silicone pattern to which taping technique is applied, thereby increasing adhesiveness and washing fastness and improving durability.

It is still another object of the present invention to improve the air permeability of the silicone pattern itself, thereby enabling air circulation without a separate hole.

According to an aspect of the present invention, preferably, in clothing in which a silicone pattern emitting anions is formed in a taping form, and the silicone pattern is formed on a clothing fabric to correspond to a shape of muscles of a human body, the silicone pattern is formed by spraying a silicone resin including anion ore powder onto a clothing fabric by a fine spray method, the anion ore powder includes one or more of tourmaline powder, monazite powder, elvan powder, and germanium powder.

Preferably, the anion ore powder according to the present invention further includes a photocatalyst material.

Preferably, the silicone pattern according to the present invention further includes a lining pattern formed of a silicone resin and a photocatalyst material around the silicone pattern.

Preferably, the anion ore powder according to the present invention is included at 5 to 10 parts by weight based on 100 parts by weight of a total liquid silicone resin, and the photocatalyst material of the anion ore powder is included at 1 to 2 parts by weight based on 100 parts by weight of the total anion ore powder.

Preferably, the photocatalyst material according to the present invention contains a metal ion precursor in an anatase type titanium dioxide photocatalyst.

Preferably, a method of manufacturing clothing in which a silicone pattern emitting anions is formed in a taping form, and the silicone pattern is formed on a clothing fabric to correspond to a shape of muscles of a human body according to the present invention includes: a liquid silicone resin preparation step of preparing a liquid silicone resin; an additive stirring step of adding an additive including anion ore powder to the liquid silicone resin and stirring; a pore-forming agent adding step of adding a pore-forming agent to form fine pores in the liquid silicone resin; an adhesion enhancing agent and curing agent addition step of adding an adhesive enhancing agent and a curing agent to the liquid silicone resin; a mold locating step of locating a mold for forming the silicone pattern on the clothing fabric; a spraying step of spraying the liquid silicone resin including the additive, the adhesion enhancing agent and the curing agent on a surface of the clothing fabric; a rolling step of expanding the liquid silicone resin applied on the clothing fabric using a roller; a curing step of curing the silicone pattern rolled in the rolling step by heating to a predetermined temperature; and a final step of finishing the cured silicone pattern by natural drying.

Preferably, in the additive stirring step according to the present invention, tourmaline powder, monazite powder, elvan powder and germanium powder are mixed at a weight ratio of 1:1:1:1 so that the anion ore powder is included at 5 to 10 parts by weight based on 100 parts by weight of the total liquid silicone resin, and 1 to 2 parts by weight of the photocatalyst material is further mixed based on 100 parts by weight of the total anion ore powder.

Preferably, in the pore-forming agent adding step according to the present invention, 0.5 to 1 part by weight of the pore-forming agent is added based on 100 parts by weight of the total liquid silicone resin.

Preferably, in the spraying step according to the present invention, a micro-spray method in which a silicone resin solution is spun into a nano-sized fiber by electrospinning through a plurality of nozzles using a high voltage is performed.

Preferably, in the spraying step according to the present invention, a process of applying the silicone resin solution by the fine spray method and removing the pore-forming agent is repeated a plurality of times.

Preferably, the spraying step according to the present invention further includes a step of forming a lining pattern around the silicone pattern using a solution in which a photocatalyst material is included in a silicone resin solution.

According to the clothing in which a silicone pattern emitting anions is formed in a taping form, and a method of manufacturing the same of the present invention, a silicone pattern is formed on a clothing fabric so that the taping functionality is realized and the anion emission functionality is further combined, thereby improving blood circulation functionality and alleviating fatigue.

Further, durability is improved by increasing adhesiveness and washing fastness by forming a silicone pattern on clothing using a silicone resin solution through a fine spray method.

Further, by forming micropores using a pore-forming agent when spraying a silicone resin solution, the silicone pattern is formed into a chain connection structure so that the silicone pattern is expanded and contracted in accordance with the expansion and contraction forces of the fabric, and thus the phenomenon that the silicone pattern is separated or dropped can be minimized.

Further, micropores are formed in the silicone pattern by spraying the silicone resin solution using a fine spray method to improve air permeability, thereby enhancing the wearing comfort of the user.

### BRIEF DESCRIPTION OF THE DRAWINGS

FIG. 1 is a configuration view showing an embodiment of clothing to which a taping technique according to the related art is applied.

FIG. 2 is a diagram showing an additive stirring step of a method of manufacturing clothing in which a silicone pattern emitting anions is formed in a taping form according to the present invention.

FIG. 3 is a diagram showing a mold locating step of a method of manufacturing clothing in which a silicone pattern emitting anions is formed in a taping faun according to the present invention.

FIG. 4 is a diagram showing a spraying step of a method of manufacturing clothing in which a silicone pattern emitting anions is formed in a taping form according to the present invention.

FIG. 5 is a diagram showing a rolling step of a method of manufacturing clothing in which a silicone pattern emitting anions is formed in a taping form according to the present invention.

FIG. 6 is a diagram showing a curing step of a method of manufacturing clothing in which a silicone pattern emitting anions is formed in a taping form according to the present invention.

FIG. 7 is a diagram showing a final step of a method of manufacturing clothing in which a silicone pattern emitting anions is formed in a taping form according to the present invention.

FIGS. 8A and 8B respectively show a microstructure state before and after the expansion of clothing in which a silicone pattern emitting anions is formed in a taping form according to the present invention.

FIG. 9 is a perspective view showing clothing in which a silicone pattern emitting anions is formed in a taping form according to the present invention.

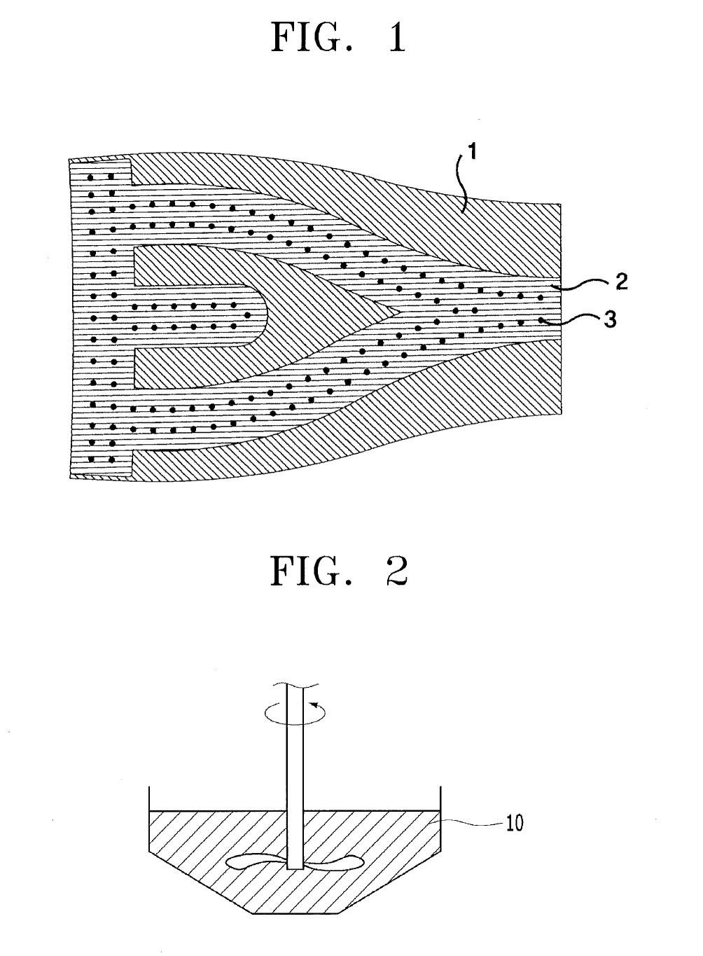

### DETAILED DESCRIPTION OF EXEMPLARY EMBODIMENTS

The embodiments and the configurations depicted in the drawings are for illustrative purposes only and should not be understood as limiting the technical scope of the invention, so it should be understood that various equivalents and modifications may exist at the time of filing this application. Although preferred embodiments of the disclosure will be described for illustrative purposes, those skilled in the art will appreciate that various modifications, additions and substitutions are possible, without departing from the scope and spirit of the invention as disclosed in the accompanying claims.

Terms described in the present disclosure may be understood as follows.

While terms such as “first” and “second,” etc., may be used to describe various components, such components must not be understood as being limited to the above terms. The above terms are used to distinguish one component from another. For example, a first component may be referred to as a second component without departing from the scope of rights of the present disclosure, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements. Further, other expressions describing relationships between components such as “between”, “immediately between” or “adjacent to” and “directly adjacent to” may be construed similarly.

Singular expressions include plural expressions unless the context clearly states otherwise. Although the terms such as “include” or “have” in this application are intended to specify the presence of stated features, numbers, steps, actions, components, parts or combinations thereof, it will be understood that the presence or addition of one or more different features, numbers, steps, actions, components, parts and combinations thereof is not excluded in advance.

Identification letters (e.g., a, b, c, etc.) in respective steps or operations are used for the sake of explanation and do not describe any particular order. The respective operations may be changed from a mentioned order unless the context clearly states otherwise. Namely, respective steps may be performed in the same order as described, may be substantially simultaneously performed, or may be performed in reverse order.

Unless otherwise defined herein, all of the terms used in this description have the meanings that are generally understood by those skilled in the art. The terms having the meanings as defined in common dictionaries should be interpreted as the meanings in the context of the art, and should not be interpreted in an ideal or excessively formal meaning unless clearly defined otherwise in this description.

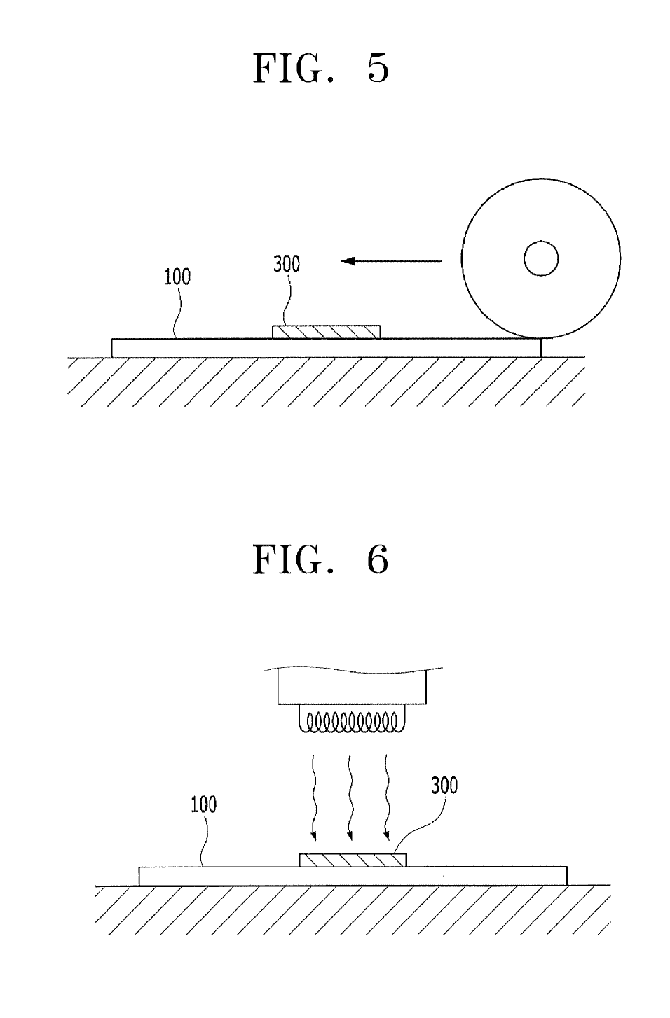

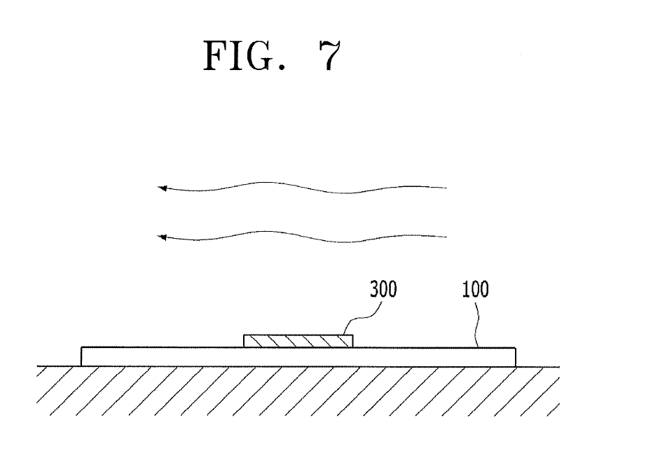

FIGS. 2 to 7 sequentially show a method of manufacturing clothing in which a silicone pattern emitting anions is formed in a taping form according to the present invention.

The silicone pattern which emits anions according to the present invention is formed on clothing using an anion-emitting material and used, thereby improving the blood circulation of the human body and alleviating fatigue by anions, and is configured such that a liquid silicone resin is sprayed onto the clothing by a fine spray method so that the silicone pattern can be firmly adhered to the clothing by silicone.

The silicone pattern which emits anions according to the present invention may include anion ore powder to form anions. The anion ore powder is ore powder which emits anions. The anion increases the ionization rate of calcium, sodium, potassium and the like, which are minerals in the blood, to purify the blood through the progress of alkalization and generates substances such as endorphins and enkephalins to increase the ionization rate of calcium and sodium in the serum, allowing blood purification, and recovery from fatigue and recovery of physical strength and activating cells of an area causing pain to be healthy, and thereby the pain can be alleviated and the blood can be purified by electrical material exchange in a cell membrane.

In the present invention, the anion ore powder may be mixed with the silicone resin after pulverizing ore that emits anions into a powder form. Examples of the ore powder which emits anions include a mixed powder of tourmaline powder, monazite powder, elvan powder, and germanium powder.

In the present invention, the anion ore powder may emit anions through the tourmaline powder, the monazite powder, the elvan powder, and the germanium powder, and the number of anions emitted by the anion ore powder may be configured to be in the range of 1000 to 2000 ions/cc.

The tourmaline has a current which is the same as a weak current of 0.06 mA required to maintain the life of human beings, and has new-far-infrared emissivity (0.923), pyroelectric (PYRO) and piezoelectric (PIEZO) properties. Such tourmaline not only emits a large amount of anions, but also converts electromagnetic waves into good energy. Thus, the tourmaline has effects of promoting metabolism, relieving pain, promoting blood circulation and hemokinesis, fast recovery from diseases, anti-aging, warming, sweating and the like.

The monazite is a mineral belonging to monoclinic phosphate minerals of cerium rare earth elements, and may form granular or monocrystalline crystals to form granules and masses. The monazite contained in the anion ore powder layer includes 50.2% silicon dioxide, 14.3% alumina oxide, 3.1% sodium oxide, 2.3% magnesium oxide, 2.3% potassium oxide, 11% calcium oxide, 1.1% phosphorus oxide and 13% iron oxide, and not only emits a large amount of infrared rays, but can also emit a larger amount of anions compared to other minerals.

The elvan serves to discharge harmful substances in the body to the outside of the body through an ion exchange action in which mineral elements, such as calcium (Ca), sodium (Na), potassium (K) and magnesium (Mg) beneficial to the human body are discharged, and serves to prevent the colonization of Escherichia coli, Pseudomonas aeruginosa, Staphylococcus aureus and molds by an antimicrobial action, decompose and remove odors, and is particularly effective against skin diseases, and can increase immunity and greatly help in wound healing.

The germanium activates the biological current flowing in the human body when the germanium comes into contact with the human body to improve blood circulation, thereby relieving symptoms such as knotted muscles, fatigue, pain and the like, inhibits the accumulation of fatigue substances and also enhances the natural healing power inherent in humans, and has the effect of adjusting body balance such as relieving muscular fatigue in sports that entail a lot of movements, pain of muscles and joints accumulated in the daily life, shoulder stiffness, backaches, neurological diseases and the like, or alleviation of mental fatigue caused by stress.

Further, the anion ore powder according to the present invention may further include ketoprofen. The ketoprofen is used as a nonsteroidal anti-inflammatory drug, and the ketoprofen does not cause a blood concentration thereof to rapidly increase and the drug can be rapidly and continuously delivered to the skin tissue.

Further, the anion ore powder of the present invention may further include a photocatalyst material. The photocatalytic material is a material which absorbs light and promotes a chemical reaction. The photocatalytic material is mixed with anion ore to reduce the degree of contamination of the silicone pattern surface, thereby suppressing bacterial propagation and enhancing the efficiency of anion emission.

An anatase type titanium dioxide photocatalyst having nano-sized pores may be used as the photocatalyst, and the titanium dioxide photocatalyst may further include a metal ion precursor. The metal ion of the metal ion precursor serves to promote the decomposition and adsorption of harmful substances.

The photocatalyst material of the present invention may be mixed with the anion ore powder to form a pattern on clothing together with the liquid silicone resin, or may be formed as a separate lining pattern around the silicone pattern as shown in FIG. 9.

Further, the silicone pattern which emits anions according to the present invention is formed to correspond to the shape of muscles of the human body, and is configured to have the same effects as those of Kinesio taping and sports taping and to realize taping functionality by applying a pressure to a muscular region by the adhesive strength of silicone itself and the high elasticity of the fabric.

Hereinafter, a method of manufacturing clothing in which a silicone pattern which emits anions is formed thereon according to the present invention will be sequentially described.

The method of manufacturing clothing in which a silicone pattern emitting anions is formed in a taping form, and the silicone pattern is formed on a clothing fabric to correspond to a shape of muscles of a human body according to the present invention includes: a liquid silicone resin preparation step (S100) of preparing a liquid silicone resin; an additive stirring step (S200) of adding an additive including anion ore powder to the liquid silicone resin and stirring; a pore-forming agent adding step (S300) of adding a pore-forming agent to form fine pores in the liquid silicone resin; an adhesion enhancing agent and curing agent addition step (S400) of adding an adhesive enhancing agent and a curing agent to the liquid silicone resin; a mold locating step (S500) of locating a mold for forming the silicone pattern on the clothing fabric; a spraying step (S600) of spraying the liquid silicone resin including the additive, the adhesion enhancing agent and the curing agent on a surface of the clothing fabric; a rolling step (S700) of expanding the liquid silicone resin applied on the clothing fabric using a roller; a curing step (S800) of curing the silicone patterned rolled in the rolling step by heating to a predetermined temperature; and a final step (S900) of finishing the cured silicone pattern by natural drying.

The liquid silicone resin preparation step (S100) is a step of heating a silicone crystal to liquefy the crystal to prepare a liquid silicone resin, that is, a step of forming a basic liquid for forming the silicone pattern 300.

When the silicone resin is formed, as shown in FIG. 2, an additive stirring step (S200), in which the liquid silicone resin is contained in a stirring device 10 and anionic ore powder is added and mixed therein, is performed.

The anionic ore powder mixed in the additive stirring step (S200) may be a powder formed by mixing tourmaline powder, monazite powder, elvan powder, and germanium powder. The mixed powder may be included in an amount of 5 to 10 parts by weight based on 100 parts by weight of the total liquid silicone resin.

In the additive stirring step (S200), an example in which the anion ore powder is mixed with the liquid silicone resin is described, but liquid urethane, liquid rubber or the like may be added to improve the physical properties or functionality of the silicone patch to be prepared, and inks and pigments may be added to express various colors and textures. Since such a configuration is well known to those skilled in the art, a detailed description thereof will be omitted.

Further, ketoprofen may be further included in the additive adding step (S200). The ketoprofen is used as a nonsteroidal anti-inflammatory drug, and the drug can be delivered quickly and continuously to skin tissue without a rapid increase in a blood concentration thereof. In the present invention, the ketoprofen may be used in an amount of 0.5 to 1.5 parts by weight based on 100 parts by weight of the total anion ore powder.

Further, in the additive stirring step (S200), a photocatalyst material may be further included. The photocatalyst material may contain a metal ion precursor in an anatase type titanium dioxide photocatalyst, and may be included at 1 to 2 parts by weight based on 100 parts by weight of the total anion ore powder.

When all the additives are stirred in the additive stirring step (S200), a pore-forming agent adding step (S300) of adding a pore-forming agent to form separate pores after the liquid silicone resin is applied is performed.

In the pore-forming agent adding step (S300), it is possible to prevent the surface of the fabric 100 from being completely shielded by the silicone pattern 300 by partially forming micropores in the silicone pattern 300 covering the surface of the fabric 100, so that the silicone pattern 300 can also be expanded in accordance with the degree of expansion of the fabric 100.

The pore-forming agent may include a chemical component which is included in the silicone resin and applied to the fabric 100, and then removed using a method such as of chemical removal of the pore-forming agent or in the manner of inherently disappearing such as vaporization.

For example, the pore-forming agent may be formed by mixing water and an alcohol at a predetermined ratio, so that the pore-forming agent may be vaporized and removed in a natural drying process, or only the pore-forming agent may be removed except the silicone resin by a special solvent.

The pore-forming agent may be sprayed in a fine spraying manner to be sprayed onto the surface of the fabric 100, and removed to partially form pores on the silicone resin pattern 300, so that the silicone resin pattern 300 is formed in a chain connection manner.

The pore-forming agent is preferably included in an amount of 0.5 to 1 part by weight based on 100 parts by weight of the total liquid silicone resin.

When all the additives are stirred in the additive stirring step (S200), an adhesion enhancing agent and curing agent addition step (S400) of adding an adhesive enhancing agent and a curing agent to the liquid silicone resin including the additives is performed.

In the present invention, the adhesion enhancing agent and the curing agent are separately added to the liquid silicone resin without being added in the additive adding step in which the anion ore powder is added to the liquid silicone resin and mixed, so that the liquid silicone resin is uniformly mixed with the anion ore powder, pigments and the like in the additive adding step.

In the present invention, the adhesion enhancing agent may be included at 0.5 to 1.5 parts by weight based on 100 parts by weight of the total liquid silicone resin, and the curing agent may be included at 1 to 2 parts by weight based on 100 parts by weight of the total liquid silicone resin. It is important to lower the content of the adhesion enhancing agent of the present invention in comparison with the existing inventions considering that the adhesion enhancing agent is sprayed by the fine spay method.

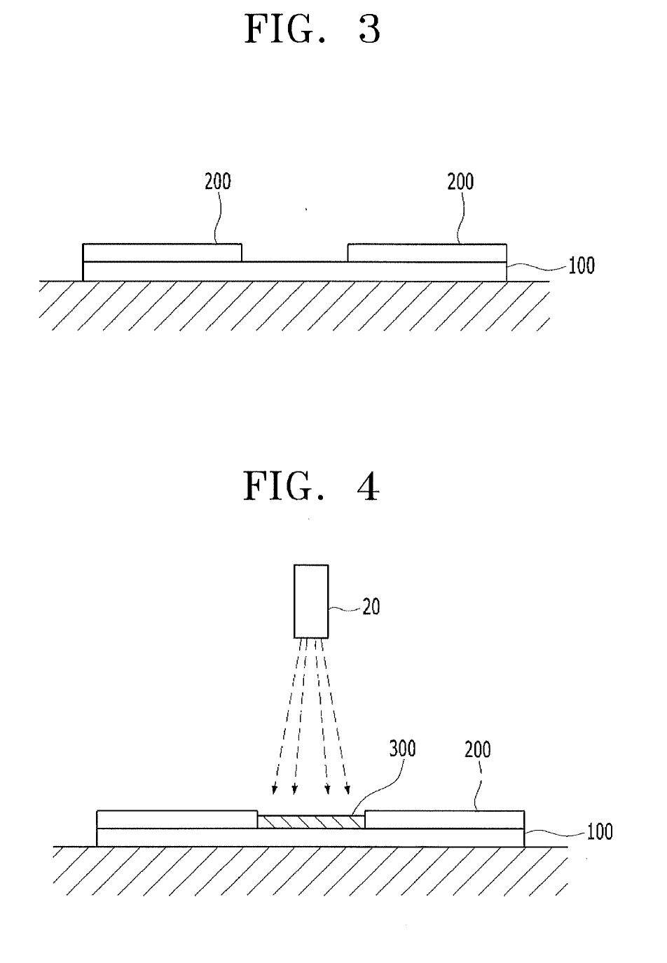

When the silicone resin for forming the silicone pattern 300 is prepared, a mold locating step (S500) of locating a mold 200 for forming the silicone pattern 300 on the clothing fabric 100 is performed as shown in FIG. 3.

Since the silicone pattern 300 of the present invention is formed by the fine spray method and the silicone pattern 300 should not be formed in portions other than the pattern, the mold 200 formed to correspond to the pattern form is located on the surface of the clothing fabric 100 to prepare to form the silicone pattern 300.

When the mold 200 corresponding to the silicone pattern 300 is located, a spraying step (S600) of applying the prepared silicone resin by the fine spray method to the surface of the fabric 100 is performed. In the spraying step S600, ultrafine pores can be formed in the silicone resin pattern 300 by applying a silicone resin to the surface of the fabric 100 by a fine spray method.

In the fine spray method, the silicone resin solution may be spun into nano-sized fibers by electrospinning through a plurality of nozzles 20 using a high voltage.

In the fine spray method, it is preferable to form the silicone pattern 300 through several times of stacking, in which a primary silicone resin solution is applied in an electrospinning manner, a pore removing agent is removed, a secondary silicone resin solution is applied, and then a pore removing agent is removed.

That is, a pore removing agent is removed after applying the silicone resin solution to form micropores, and such a process is repeated to form the silicone resin pattern 300. In this process, micropores are formed in the silicone pattern 300 and the silicone pattern 300 is formed in a chain connection manner, and thus the silicone pattern 300 may be expanded and contracted in accordance with the degree of expansion and contraction of the fabric 100.

The spraying step S600 may further include a step of forming a lining pattern S610 around the silicone pattern 300 using a photocatalyst material. As shown in FIG. 9, a lining pattern 310 using only the photocatalyst material and silicone resin is further formed around the silicone pattern 300 to reduce the harmful substances around the silicone pattern 300 including the anion material and further improve the anion emission efficiency.

When all the silicone patterns 300 are formed on the fabric 100 as described above, a rolling step S700 of expanding the liquid silicone to a predetermined thickness and width is performed.

The rolling step S700 may be a step of forming the liquid silicone on the clothing fabric and then pressing the silicone using a roller or a dedicated press so that the liquid silicone is adhered by seamless welding. The mold 200 may be removed before the rolling step (S700), or the mold 200 may be removed after rolling in a state where the mold 200 has been located.

When the silicone is adhered by the rolling step S700, a curing step (S800) for heating and curing at a predetermined temperature is performed. The curing step (S800) is a step of introducing the silicone expanded to a predetermined thickness and width into a heating furnace and curing.

After the curing step (S800) is completed, the clothing may be dried in a natural drying state for a certain period of time, followed by cutting and finishing to produce clothing having the silicone pattern 300 emitting anions (S900).

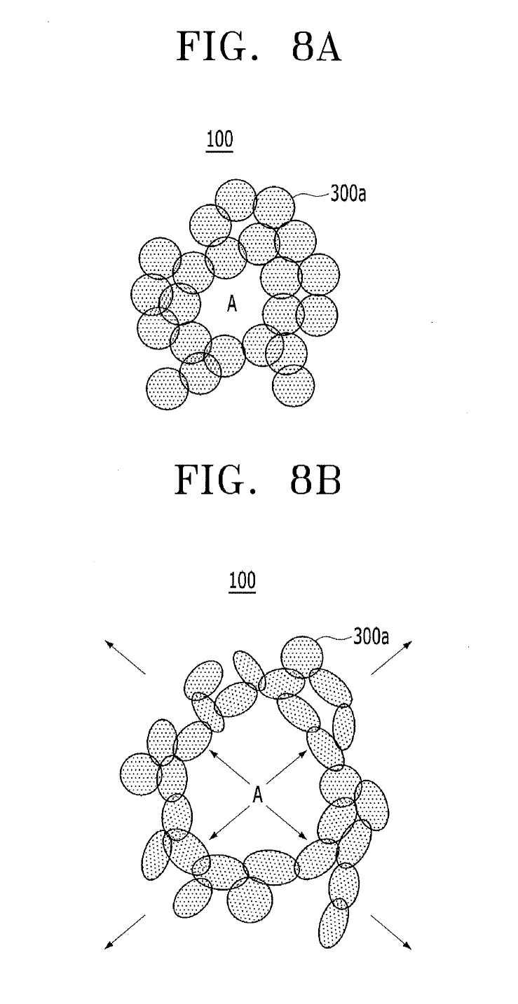

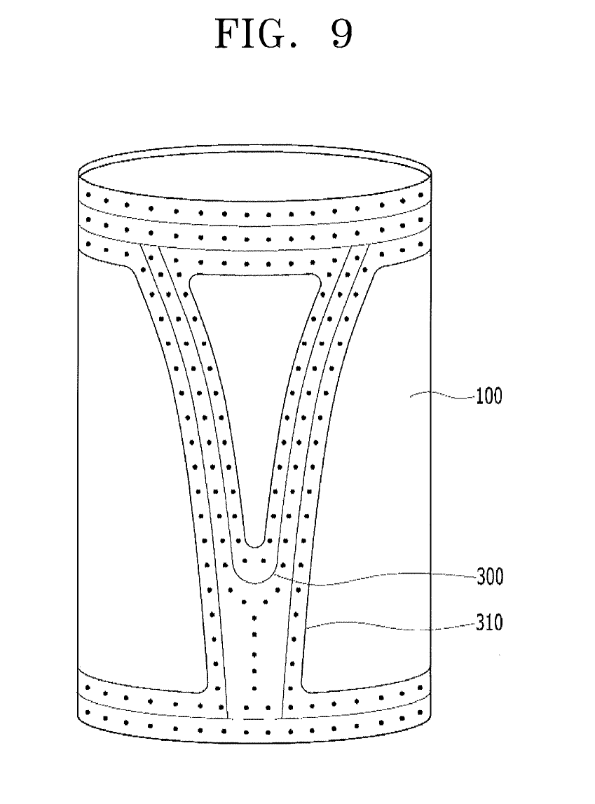

FIGS. 8A and 8B show an expanded structure state of clothing in which a silicone pattern emitting anions is formed in a taping form as prepared above.

As shown in the drawings, when the pore removing agent contained in the silicone resin solution is removed after application of the silicone solution, a partial pore A is formed as shown in FIG. 8A. Silicone resin droplets 100a are cured on the surface of the fabric 100 in a manner such as the chain connection manner by the pore A.

In this state, when the fabric 100 is expanded as shown in FIG. 8B, the pore A is also expanded and contracted in accordance with the expansion and contraction forces of the fabric 100, and the silicone resin droplets 100a around the pore A are expanded and contracted in a chain connection state, and thereby may be expanded in accordance with the expansion and contraction force of the fabric.

It can be seen that the silicone pattern can relatively expand in accordance with the degree of expansion of the fabric 100 as compared to the case where the silicone pattern 300 covering all the surfaces of the conventional fabric 100 expands only according to the degree of expansion of the silicone itself.

Due to such a structure, the silicone pattern 300 can maintain the adhesive force for a longer time on the surface of the fabric 100, and durability can be improved.

Further, the silicone pattern 300 formed by the fine spray method itself has ultrafine pores smaller than the micro-sized pore A formed by the pore removing agent.

The ultrafine pores of the silicone pattern 300 formed by the fine spray method are formed to a size large enough to allow air to pass therethrough although water molecules are not allowed to pass therethrough, thereby improving the air permeability of the silicone pattern 300 itself.

Further, the photocatalyst material contained in the anion ore powder is a material which absorbs light and promotes a chemical reaction, and is mixed with the anion ore to reduce the contamination degree of the silicone pattern surface, thereby suppressing the propagation of bacteria and enhancing the anion emission efficiency.

Experimental examples of the anion emission efficiency of the anion ore powder containing the photocatalyst material will be described in more detail below.

First, 8 parts by weight of an anionic ore powder was added to 100 parts by weight of the total liquid silicone resin and mixed. In Experimental Example 1, the anion ore powder was formed by mixing tourmaline powder, monazite powder, elvan powder, and germanium powder in a weight ratio of 1:1:1:1. In Experimental Example 2, the anion ore powder was formed by mixing tourmaline powder, monazite powder, elvan powder, and germanium powder in a weight ratio of 1:1:0.9:1, and a photocatalyst material was further mixed to be included at 1 part by weight based on 100 parts by weight of the total anion ore powder.

Next, liquid urethane, rubber, inks and pigments were added to the liquid silicone resin mixed with the anion ore powder of Experimental Examples 1 and 2 and uniformly mixed. Then, an adhesion enhancing agent and a curing agent were further added.

Next, a silicone resin layer was formed on the surface of the fabric of Experimental Examples 1 and 2 by applying using a fine spray method for a total of 10 times. Then, clothing having silicone formed thereon was pressed using a dedicated press machine and cured at a temperature of 70° C. for 3 minutes, and the cured clothing was separated and cooled to form clothing of Experimental Examples 1 and 2 in which the silicone pattern was formed.

The fabrics of Experimental Examples 1 and 2 thus prepared were attached to Subjects 1 and 2 and the subjects were allowed to live under the same conditions for one week, and then the number of emitted anions was measured over time.

Measurement of anions was performed by measuring the number of emitted anions (number/cm3) under the conditions of a temperature of 232° C., a humidity of 505 RH and 30 to 100 atmospheric anions/cm3 using an anion meter (COM SYSTEM. INC., model name: COM-3010).

TABLE 1

Elapsed time (hr)

| | 0 hr | 42 hr | 84 hr | 108 hr | 168 hr |
|---|---|---|---|---|---|
| Experimental | 421 | 316 | 213 | 164 | 108 |
| Example 1 | | | | | |
| (number/cm³) | | | | | |
| Experimental | 423 | 309 | 257 | 232 | 201 |
| Example 2 | | | | | |
| (number/cm³) | | | | | |

As can be seen from the above-described experimental example, in Experimental Example 1 in which the photocatalyst material was not included, the number of anions was reduced to 25% of the initial number of anions, but in Experimental Example 2 in which the photocatalyst material was included, the number of anions was reduced to 47% of the initial number of anions after 168 hours.

Although embodiments have been described with reference to a number of illustrative embodiments thereof, it should be understood that numerous other modifications and embodiments can be devised by those skilled in the art that will fall within the spirit and scope of the invention as defined by the following claims.

What is claimed is:

1. A garment comprising:
a plurality of silicone patterns formed on the garment in a taping form wherein at least some portion of the silicone patterns is formed to correspond to muscles of a wearer;
wherein the silicone patterns include sprayed silicone resin and anion ore powder so as to emit anions,
wherein the anion ore powder includes one or more selected from the group consisting of tourmaline powder, monazite powder, elvan powder and germanium powder.

2. The garment of claim 1, wherein the anion ore powder includes a photocatalyst material containing a metal ion precursor in an anatase type titanium dioxide photocatalyst.

3. The garment of claim 1, wherein the silicone pattern further includes a lining pattern formed of the silicone resin and the photocatalyst material around the silicone pattern.

4. The garment of claim 1, wherein the anion ore powder is included at 5 to 10 parts by weight based on 100 parts by weight of a total liquid silicone resin, and
the photocatalyst material of the anion ore powder is included at 1 to 2 parts by weight based on 100 parts by weight of the total anion ore powder.

5. A method of manufacturing a garment having silicone patterns formed on the garment in a taping form corresponding to muscles of a wearer, the method comprising the steps of:
preparing a liquid silicone resin;
adding and stirring an additive of anion ore powder to the liquid silicone resin;
adding a pore-forming agent to form fine pores in the liquid silicone resin;
adding an adhesive enhancing agent and a curing agent to the liquid silicone resin;
spraying the liquid silicone resin onto a surface of the garment;
rolling the liquid silicone resin sprayed on the surface of the garment using a roller; and
curing the silicone pattern rolled on the surface of the garment by heating at predetermined temperatures.

6. The method of claim 5, wherein the additive of anion ore powder includes tourmaline powder, monazite powder, elvan powder and germanium powder which are mixed at a weight ratio of 1:1:1:1 so that the anion ore powder is included at 5 to 10 parts by weight based on 100 parts by weight of the total liquid silicone resin, and
wherein 1 to 2 parts by weight of the photocatalyst material based on 100 parts by weight of the total anion ore powder is further mixed with the anion ore powder.

7. The method according to claim 5, wherein 0.5 to 1 part by weight of the pore-forming agent is added based on 100 parts by weight of the total liquid silicone resin during the step of adding the pore-forming agent.

8. The method according to claim 5, wherein a micro-spray method is used in the step of spraying the liquid silicone resin in which a silicone resin solution is spun into a nano-sized fiber by electro spinning through a plurality of nozzles using a high voltage is performed.

9. The method according to claim 8, wherein, in the step of spraying the liquid silicone resin, a step of removing the pore-forming agent from the liquid silicone resin is repeatedly performed after the step of spraying the silicone resin solution with fine spraying.

10. The method according to claim 8, wherein the step of spraying the liquid silicone resin further includes a step of forming a lining pattern around the silicone pattern using a solution in which a photocatalyst material is included in a silicone resin solution.
